(19) United States
(12) Patent Application Publication
(10) Pub. No.: US 2026/0170868 A1
(43) Pub. Date: Jun. 18, 2026

(54) IMAGE CAPTURING APPARATUS, IMAGE CAPTURING METHOD, AND STORAGE MEDIUM

(71) Applicant: CANON KABUSHIKI KAISHA, Tokyo (JP)

(72) Inventor: TAKESHI UCHIDA, Kanagawa (JP)

(21) Appl. No.: 19/404,361

(22) Filed: Dec. 1, 2025

(30) Foreign Application Priority Data
Dec. 12, 2024 (JP) 2024-218117

(51) Int. Cl. G06V 40/19; G06V 40/18; H04N 23/611

(52) U.S. Cl. CPC G06V 40/19; G06V 40/193; G06V 40/197; H04N 23/611

(57) ABSTRACT

An image capturing apparatus has an image capturing element configured to capture subject images; a view finder for confirming images of subjects; and an ocular image sensor configured to capture ocular images of a user who is looking into the viewfinder, and determines a state of the ocular images; identifies the user based on the ocular images; assigns user information relating to the user who has been identified to the subject images that have been captured by the image capturing element while the user is looking into the viewfinder; and performs control such that in a case in which it has been determined that the state of the ocular images does not fulfill predetermined conditions, the user information is not assigned to the subject images.

### BACKGROUND

### Field

The present disclosure relates to an image capturing apparatus, an image capturing method, a storage medium, and the like.

### Description of the Related Art

In recent years, there has been a desire for a function that performs recording by specifying a photographer of images and video images in order to manage copyright claims and to guarantee authenticity. Japanese Unexamined Patent Application, First Publication No. 2001-94847 discloses a method in which personal authentication and identification are performed by capturing images of an eye that has been brought near to the eyepiece of a viewfinder when a camera is being used, and this information is added to the images.

However, the method of Japanese Unexamined Patent Application, First Publication No. 2001-94847 does not take into consideration that there will be changes in the precision of the video image of the eye that is being captured by the image capturing element, the size of the eye in the angle of view, and the like when the user brings their eye toward the viewfinder in order to come into contact therewith at the time when the user begins to the use the camera.

Therefore, ocular images become blurry, and there are large changes in the size and the like of the ocular images due to the image capturing timing for the ocular image. When personal identification is performed using such ocular images, there are cases in which the identification precision is lowered.

### SUMMARY

An image capturing apparatus according to an embodiment of the present application has an image capturing element configured to capture subject images; a viewfinder for confirming images of subjects; and an ocular image sensor configured to capture ocular images of a user who is looking into the viewfinder; wherein the image capturing apparatus: determines a state of the ocular images; identifies the user based on the ocular images; assigns user information relating to the user who has been identified to the subject images that have been captured by the image capturing element while the user is looking into the viewfinder; and performs control such that in a case in which it has been determined that the state of the ocular images does not fulfill predetermined conditions, the user information is not assigned to the subject images.

Further features of the present disclosure will become apparent from the following description of embodiments with reference to the attached drawings.

### BRIEF DESCRIPTION OF THE DRAWINGS

FIG. 1A is a front perspective view of an image capturing apparatus in a First Embodiment of the present disclosure, and FIG. 1B is a rear perspective view of the image capturing apparatus in the First Embodiment of the present disclosure.

FIG. 2 is a cross-section diagram in which a camera housing 1B has been cut on a YZ plane formed by a Y axis and an Z axis that are shown in FIG. 1A.

FIG. 3 is a functional block diagram showing a configurational example of the image capturing apparatus according to the First Embodiment.

FIG. 4 is a diagram showing an example of a field of view inside of a viewfinder in the First Embodiment.

FIG. 5 is a diagram explaining the principle of an ocular information detection method in the First Embodiment.

FIG. 6 is a flowchart showing a processing example for an image capturing method using a personal identification unit in the First Embodiment.

FIG. 7A is a diagram showing an example of an ocular image that is projected onto an ocular image sensor 17, FIG. 7B is a diagram showing an example of luminance distribution in an area α of FIG. 7A, and FIG. 7C is a diagram showing an example of a relationship between a distance z and an interval between two reflected images.

FIG. 8 is a schematic diagram explaining a determination method for a temporal variation amount for the distance z from an eye to the viewfinder in the First Embodiment.

FIG. 9 is a schematic diagram explaining a configurational example of a personal identification unit 207.

FIG. 10 is a diagram showing an example of a correspondence table for feature amounts and people that has been stored in a feature amount storage unit 303.

FIG. 11 is a diagram explaining a configurational example of a CNN 302 that performs personal identification from two-dimensional image data.

FIG. 12 is a diagram explaining an example of the details of feature detection processing on a feature detection cell surface, and feature integration processing on a feature integration cell surface.

FIGS. 13A, and B are schematic diagrams explaining an example of a head-mounted-type XR device that serves as the image capturing apparatus according to a Second Embodiment.

FIG. 14 is a flowchart showing an example of personal identification processing according to a Third Embodiment.

FIG. 15 is a flowchart showing an example of personal identification processing according to a Fourth Embodiment.

FIG. 16 is a diagram explaining an example of a correspondence table for feature amounts, people, and distances z′ according to a Fourth Embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate descriptions will be omitted or simplified.

### First Embodiment

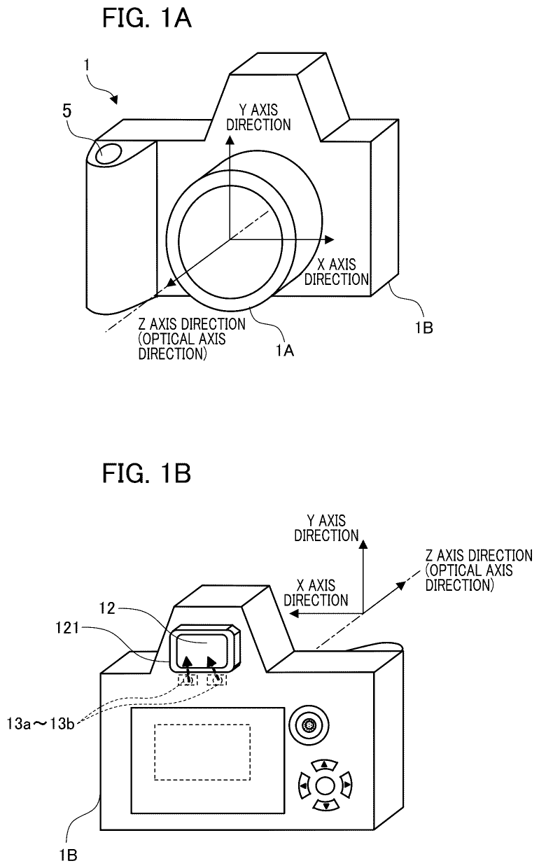

FIGS. 1(A), and (B) show examples of the outside of a digital camera 1 having an ocular information acquisition function and a personal identification function according to the First Embodiment of the present disclosure. FIG. 1(A) is a front perspective diagram, and FIG. 1(B) is a rear perspective diagram.

In the present embodiment, as is shown in FIG. 1(A), the digital camera 1 is configured by a replaceable image capturing lens 1A, and the camera housing 1B that serves as the camera body. In addition, a release button 5, which is an operating member that receives image capturing operations from a user, is disposed on the digital camera 1.

Note that the release button 5 has a switch SW1, and a switch SW2, which are not shown. SW1 is a switch for turning the release button 5 ON with a first stroke, and beginning photometry, ranging, line of sight detection operations, and the like for the camera. SW2 is a switch for turning the release button 5 ON with a second stroke, and beginning a release operation.

In addition, as is shown in FIG. 1(B), an ocular window frame 121 and an ocular lens 12 for allowing the user to look at a display element 10, which is included inside of the camera and will be described below, is disposed on the rear side of the digital camera 1. In addition, a plurality of light sources 13a, and 13b that illuminate the eye are also disposed around the ocular lens 12.

The above-described digital camera functions as an image capturing apparatus that captures images. In addition, the above-described ocular window frame 121 and the ocular lens 12 for the user to look into function as a viewfinder for confirming images of subjects. Note that the digital camera of the present embodiment is able to capture still images and video images of subjects. In addition, in the present embodiment, “to image capture” and “to capture” are used with the same meaning.

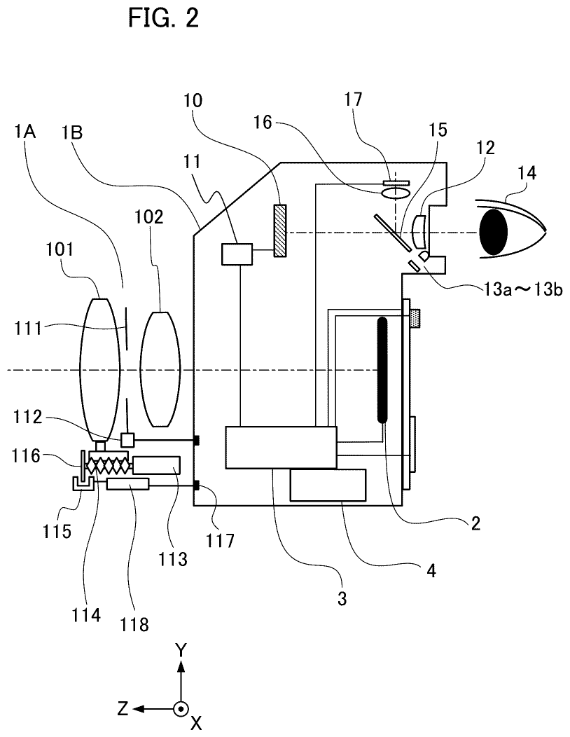

FIG. 2 is a cross sectional diagram in which the camera housing 1B has been cut on a YZ plane formed by the y axis and the z axis that are shown in FIG. 1A, and shows a summary of a configuration of the digital camera 1. Note that in FIG. 1 and FIG. 2, the corresponding portions are displayed with the same numbers.

In FIG. 2, 1A shows an image capturing lens in an interchangeable lens camera. Although in FIG. 2, for convenience, two lenses, a lens 101, and a lens 102 are shown inside of the image capturing lens 1A, the image capturing lens 1A may also be configured by three or more lenses.

1B shows the housing unit for the camera body, 2 is an image capturing element for capturing subject images, and for example, consists of a CCD and CMOS image sensor, and is disposed on a planned image forming surface of the image capturing lens 1A of the digital camera 1. Note that the image capturing element 2 of the present embodiment performs image capturing plane phase difference AF using a well-known method, and therefore, has a pixel configuration that is able to output two types of image signals having parallax.

The digital camera 1 also includes a CPU 3 that serves as a computer that controls the entirety of the camera, and a memory 4 that stores images that have been captured by the image capturing element 2. In addition, the display element 10, which is configured by a liquid crystal and the like and is for displaying the images that have been captured, a display element drive circuit 11 that drives the display element 10, and the ocular lens 12 for viewing the subject images that have been displayed on the display element 10 are disposed on the digital camera 1.

13a to 13b are light sources consisting of infrared light emitting diodes and the like for illuminating an eye 14 of a photographer, and they are disposed around the ocular lens 12. An orientation (line of sight direction) and the like of an eye are detected based on the positional relationship between a corneal light reflex image and the pupil of the eye of the photographer (user) that has been illuminated by these light sources.

The corneal light reflex image and the like of the eye 14 that has been illuminated by the light sources 13a to 13b pass through the ocular lens 12, are reflected by a beam splitting device 15 consisting of a half mirror, and an image is formed on a light receiving surface of the ocular image sensor 17 such as a CMOS sensor and the like by a light receiving lens 16. In addition, an ocular image for the user (photographer) who is looking into the viewfinder is captured by the ocular image sensor 17.

Note that the position of the pupil of the eye 14 of the photographer via the light receiving lens 16 and the position of the ocular image sensor 17 are in a conjugate image forming relationship. The positional relationship between the ocular image (image of the pupil) that has been formed on the ocular image sensor 17 and the corneal light reflex images for the light sources 13a to 13b is determined using a predetermined algorithm that will be explained below.

111 is an aperture that has been provided inside of the lens 1A, 112 is an aperture drive apparatus, 113 is a lens drive-use motor, and 114 is a lens drive member consisting of drive gears and the like. 115 is an opto-isolator, and detects a rotation amount of a pulse plate 116 that works in joint operation with the lens drive member 114, and transmits this to a focus adjustment circuit 118.

The focus adjustment circuit 118 drives the lens drive-use motor 113 by a predetermined amount based on information from the opto-isolator 115 and information for the lens drive amount from the camera side, and moves the image capturing lens 101 to a focus position. 117 is a mount contact that becomes an interface between the camera and the lens.

In this manner, the digital camera 1, which serves as an image capturing apparatus, has at least an image capturing element that captures subject images, a viewfinder for displaying images of subjects, and an ocular image sensor that captures ocular images of a user who is looking into the viewfinder.

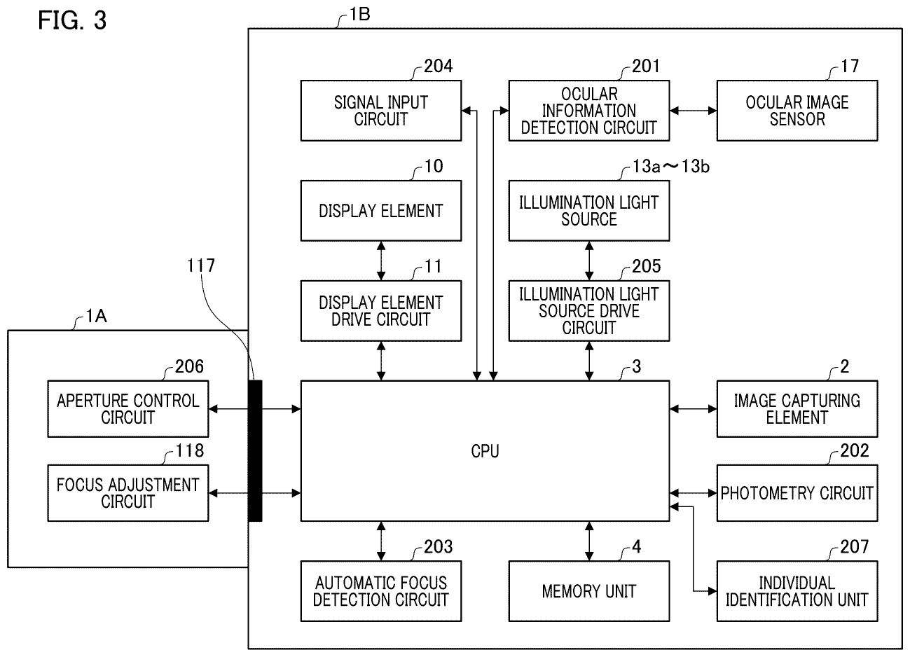

FIG. 3 is a functional block diagram showing a configurational example of an image capturing apparatus according to the First Embodiment. The articles in FIG. 3 that are the same as articles in FIG. 2 are given the same numbers. Note that a portion of the functional blocks that are shown in FIG. 3 are realized by a CPU that serves as a computer, and the like that is included in the image capturing apparatus executing a computer program that has been stored on a memory that serves as a storage medium.

However, a portion or the entirety of these blocks may also be made so as to be realized by hardware. An application-specific integrated circuit (ASIC), a processor (a reconfigurable processor, a DSP), and the like can be used as this hardware.

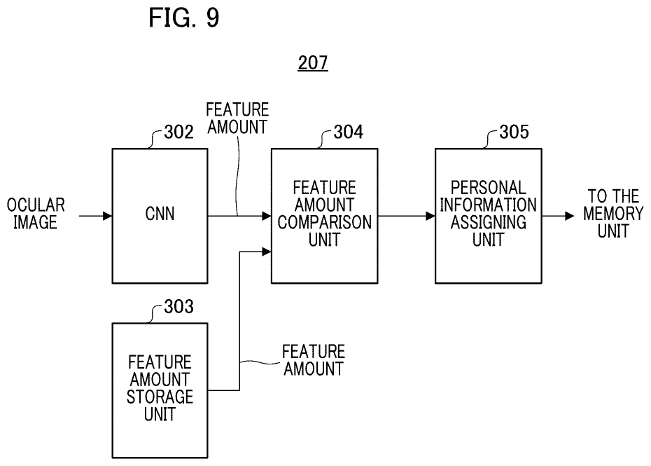

In addition, each of the functional blocks that are shown in FIG. 3 may be housed inside the same housing, and they may also be configured by separate apparatuses that have been connected to each other via signal paths. Note that the above explanation relating to FIG. 3 also applies to FIG. 9, which will be explained below, in the same manner.

An ocular information detection circuit 201, a photometric circuit 202, an automatic focus detection circuit 203, a signal input circuit 204, the display element drive circuit 11, and an illumination light source drive unit 205 are connected to the CPU 3 of a microcomputer that has been housed inside of the camera body.

In addition, the CPU 3 performs signal transmission via the focus adjustment circuit 108 that has been disposed inside of the image capturing lens, and the aperture control circuit 206 and the mount contact 117 that are included in the above-described aperture drive apparatus 112. The memory 4 that is attached to the CPU 3 stores image capturing signals from the image capturing element 2 and the ocular image sensor 17 along with storing line of sight correction data for correcting individual differences in lines of sight.

The ocular information detecting circuit 201 A/D converts image signals of the eye 14 from the ocular image sensor 17 and transmits this image information to the CPU 3. The CPU 3 extracts each feature point from the ocular image that is necessary for the ocular information detection according to a predetermined algorithm that will be explained below, and further calculates the ocular information for the photographer from the positions of each of the feature points.

The photometric circuit 202 amplifies a luminance signal output corresponding to the brightness of a subject field based on a signal that is obtained from the image capturing element 2, which also has the role of a photometry sensor, then performs logarithmic compression and A/D conversion on this amplified signal, and transmits it to the CPU 3 as subject field luminance information

The automatic focus detection circuit 203 A/D converts a signal voltage from a plurality of pixels that are able to output two types of image signals having parallax for use in phase difference detection inside of the image capturing element 2, and transmits this to the CPU 3. The CPU 3 calculates the distances until subjects that correspond to each focus detection point based on the two kinds of image signals having parallax. Note that this is a well-known technology that is known as image capturing surface phase difference AF. Note that in the present embodiment, there are, for example, 180 focus detection points provided on the image capturing surface of the image capturing element 2.

The signal input circuit 204 is connected to the switch SW1 and the switch SW2 of the release button 5, and the on and off signals for both the switch SW1 and the switch SW2 are transmitted to the CPU 3. 207 is a personal identification unit, and is a unit for identifying the photographer (user) based on an ocular image. Note that the configuration of the personal identification unit 207 will be explained below using FIG. 9.

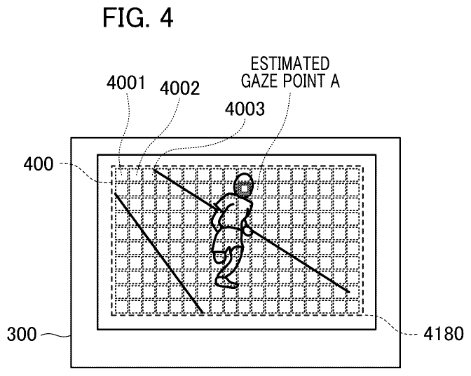

FIG. 4 is a diagram showing an example of a field of view inside of the viewfinder in the First Embodiment, and shows a state in which an image of a subject is displayed on the display element 10. In FIG. 4, 300 is a field of view mask, and 400 is a focus detection area.

There are, for example, 180 focus detection points on the image capturing surface of the image capturing element 2 of the present embodiment, and ranging point visuals 4001-4180, which correspond to each of these 180 focus detection points, are displayed as superimposed on the subject images in the field of view image inside of the viewfinder in FIG. 4. Note that in FIG. 4, inside of these visuals, visuals that correspond to a current estimated gaze position are displayed by boxes that serve as an estimated gaze point A.

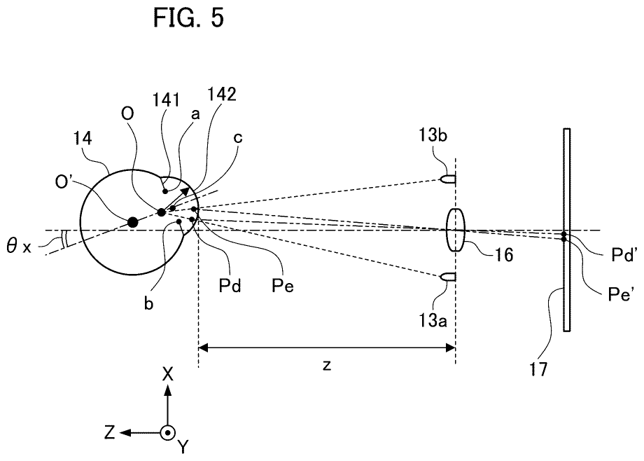

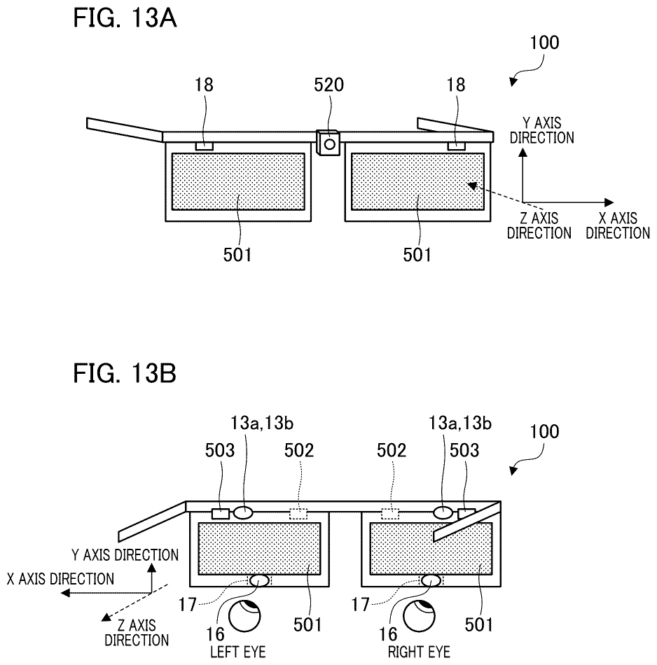

FIG. 5 is a diagram explaining the principle of the ocular information detection method in the First Embodiment, and shows the gist of an optical system for performing the ocular information detection of the above-described FIG. 2. In FIGS. 5, 13a, and 13b are light sources such as light emitting diodes and the like that irradiate an observer with infrared light.

The light sources 13a, and 13b are for example, disposed so as to approximately symmetrical with a light axis of the light receiving lens 16, and illuminate the eye 14 of the observer. A portion of the light that has been reflected off of the eye 14 is collected in the ocular image sensor 17 by the light receiving lens 16. Note that 141 is a pupil, 142 is a cornea, a, and b are the edges of the pupil 141, and c is the center of the pupil 141.

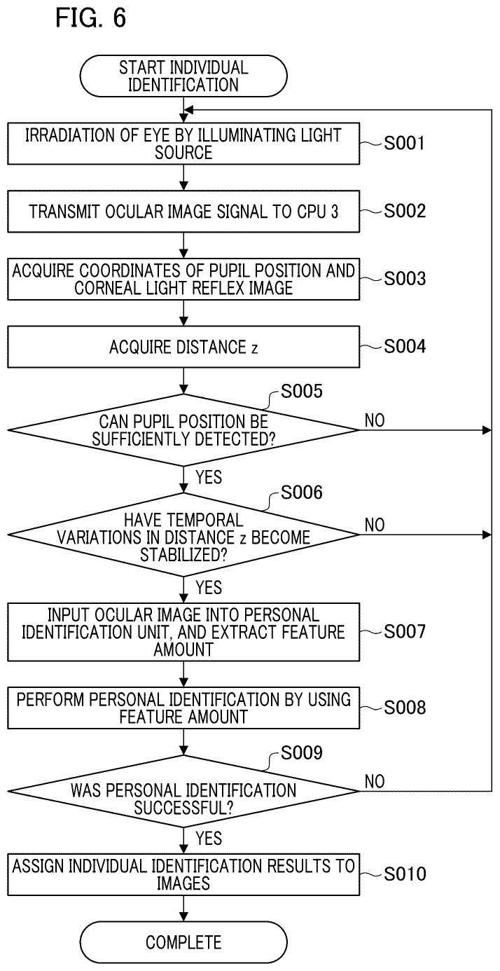

Below, using FIGS. 6 to 12, the personal identification unit 207 that is applied in the present embodiment will be explained. FIG. 6 is a flowchart showing a processing example for an image capturing method that uses the personal identification unit in the First Embodiment. Note that the processes for each step of the flowchart in FIG. 6 are performed in order by the CPU 3 that serves as a computer and the like executing a computer program that has been stored on the memory.

In FIG. 6, for example, image capturing is performed by turning the switch SW2 on, and when the images that have been captured are stored on the memory, the personal identification processing flow begins.

Conversely, the processing flow for FIG. 6 may also be began in a case in which an approaching eye has been detected by a sensor, which is not shown, when the user has brought their eye to the viewfinder in order to begin image capturing of a subject. In this case, it becomes such that determination processing is performed by the state determining unit to be described below when the user has brought their eye to the viewfinder in order to begin image capturing of a subject.

During step S001 of FIG. 6, the eye is irradiated by the illuminating light source. That is, infrared light is radiated towards the eye 14 of the observer by the light sources 13a, and 13b.

The ocular image of the observer that has been irradiated by the above described infrared light passes through the light receiving lens 16 and is image formed on the ocular image sensor 17, is photoelectrically converted by the ocular image sensor 17, and it becomes possible to output the ocular image from the ocular image sensor 17 as an electric signal.

Next, during step S002, the ocular image signal that has been obtained from the ocular image sensor 17 is sent to the CPU3, and during steps S003 to steps S004, the ocular information is calculated from the ocular image signal that was obtained during Step S002.

That is, during step S003, the coordinates for the pupil center and the coordinates for the corneal light reflex image are acquired. That is, the coordinates for each of the corneal reflex image Pd for the light source 13a, and the corneal light reflex image Pe for the light source 13b, and the coordinates for a point corresponding to the pupil center c, which are shown in FIG. 5 are found from the information for the ocular image signal that was obtained during step S002.

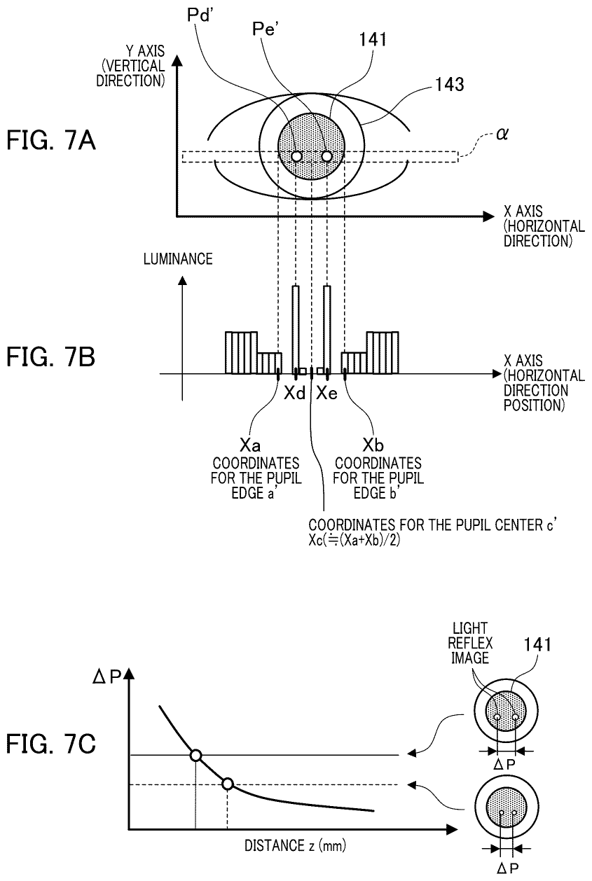

FIG. 7a is a diagram showing an example of an ocular image that is projected onto the ocular image sensor 17, FIG. 7B is a diagram showing an example of illuminance distribution in an area α of FIG. 7A, and FIG. 7C is a diagram showing an example of a relationship between a distance z and an interval between two reflected images.

The cornea 142 (FIG. 5) of the eye 14 of the observer is illuminated with infrared light that has been irradiated from the light source 13a and the light source 13b, and the corneal light reflex image Pd and the corneal light reflex image Pe, which are formed by a portion of the infrared light that has irradiated the surface of the cornea 142, are collected by the light receiving lens 16. In addition, these are image formed as the point Pd′ and the point Pe′ in the diagrams on the ocular image sensor 17.

The light beams from the edge a and the edge b (FIG. 5) of the pupil 141 are also image formed on the ocular image sensor 17 in the same manner. In FIG. 7(A), the horizontal direction is made the X axis and the vertical direction is made the Y axis. The area α of the FIG. 7A is an area for measuring the illuminance distribution (FIG. 7B) in the X axis direction (the horizontal direction) of the image Pd′ and the image Pe′ at which the corneal light reflex images for the light source 13a and the light source 13b have been image formed.

Note that in FIG. 7B, the coordinate in the X axis direction (horizontal direction) for the image Pd′ is made Xd, and the coordinate in the X axis direction (horizontal direction) for the image Pe′ is made Xe. In addition, the coordinate in the X axis direction for the image a′ that has been image formed from the light beams from the edge a of the pupil 14b is made Xa, and the coordinate in the X axis direction for the image b′ that has been image formed from the light beams from the edge b of the pupil 14b is made Xb.

In the example of the illuminance distribution that is shown in FIG. 7(B), at the coordinate Xd corresponding to the image Pd′ in which the corneal light reflect image for the light source 13a has been image formed, and the coordinate Xe corresponding to the image Pe′ in which the corneal light reflect image for the light source 13b has been image formed, a first level illuminance that is comparatively extremely strong is obtained. In contrast, in an area between Xa to Xb that corresponds to an area of the pupil 141, excluding the coordinates Xd, and Xe that have been explained above, a comparatively extremely low second level illuminance can be obtained.

In relation to this, in an area having an x coordinate value that is smaller than Xa and corresponds to an area of an iris 143 on the outer side of the pupil 141, and in an area having an X coordinate value that is larger than Xb, a value that is in between the above-described first level and second level can be obtained.

Therefore, it is possible to obtain the X coordinate Xd for the image Pd′ in which the corneal light reflex image for the light source 13a has been formed, the X coordinate Xe for the image Pe′ in which the corneal light reflex image for the light source 13b has been formed, the X coordinate Xa for the image a′ of the pupil edge, and the X coordinate Xb for the image b′ of the pupil edge based on the illuminance distribution relating to the above-described X coordinates.

In addition, as is shown in FIG. 5, in a case in which a rotational angle θx for the optical axis of the eye 14 in relation to the optical axis for the light receiving lens 16 is small, it is possible to make the coordinates Xc for the pupil center c′ that has been image formed on the ocular image sensor 17 be approximately Xc≈(Xa+Xb)/2.

In the manner that has been explained above, it is possible to acquire the X coordinate Xc for the pupil center c′ that has been image formed on the ocular image sensor 17, the X coordinate Xd for the corneal light reflex image Pd′ for the light source 13a, and the X coordinate Xe for the corneal light reflex image Pe′ for the light source 13b.

Furthermore, the distance z is acquired during step S004. The distance z is a distance from the eye of the photographer (user) until the viewfinder, and, for example, can be calculated from the intervals for two Purkinje images in the corneal image of FIG. 7(C).

The graph in FIG. 7(C) shows the correlation between an interval ΔP for the two reflex images Pd, and Pe, which are formed by the two light sources 13a, and 13b, and the distance z, which is a distance from the ocular image sensor 17 until the eye 14. As is shown in the graph in FIG. 7(C), there are non-linear monotonic decreases in the distance z along with increases in ΔP, and therefore, it is possible to uniquely calculate the distance z from the ocular image sensor 17 until the eye 14 based on ΔP.

In the present embodiment, as has been described above, the correlation for the distance z, which is a distance from the ocular image sensor 17 until the eye 14 corresponding to the interval ΔP for the two reflex images Pd, and Pe, is stored in advance on the memory in a format such as, for example, a correlation table.

Therefore, the distance z is acquired from ΔP, which has been measured, by reading out this table. However, the method for acquiring the distance z is not limited thereto, and the distance z may also be calculated from ΔP using, for example, an approximate expression, and may also be measured by providing a measuring unit for measuring the distance from the eye to the display surface.

Next, during step S005, a determination as to whether or not it has been possible to sufficiently detect the pupil position is performed. In a case in which the coordinates Xa, and Xb for the pupil edges can be pupil detected sufficiently to the extent that is necessary, the processing proceeds to step S006, and in a case in which these are not detected, the processing returns to step S001, and the image is re-acquired.

This is because in a case in which, for example, the distance from the eye to the camera is far away, and the ocular image is unclear, and the like, as was explained in FIG. 7(B), there are cases in which the level differences in the luminance between the pupil and the iris cannot be obtained, and the positions of the pupil edges cannot be detected.

That is, when capturing images of the subject with the camera, if personal identification is performed using an unclear ocular image in a state in which the photographer has not brought their eye sufficiently close enough to the viewfinder, there is a possibility that identification precision will be lowered. Therefore, during step S005, a determination as to whether or not the eye is clearly shown in the image to an extent that the pupil edge detection can be sufficiently performed is performed based on the pupil position detection results. In this context, step S005 functions as a state determination step (a state determining unit) that determines a degree of clearness to serve as a state of the ocular image.

Next, during step S006, a determination is performed as to whether or not time-series variations in the distance z, which was obtained during step S004, have become stable. If these are stable, the processing proceeds to step S007, and if they are not stable, the processing returns to step S001, and the image is re-acquired. That is, during step S006, a state determining unit determines that predetermined conditions are not fulfilled in a case in which variations in the distance from the eye to the viewfinder within a predetermined time period are greater than or equal to a predetermined threshold value.

This is because, for example, in a case in which the ocular image was acquired while the photographer was bringing their eye toward the viewfinder, the size of the ocular image will greatly change from a small state in comparison to a regular ocular image, and the variations in size are large, and therefore, there are cases in which the personal identification precision will be lowered.

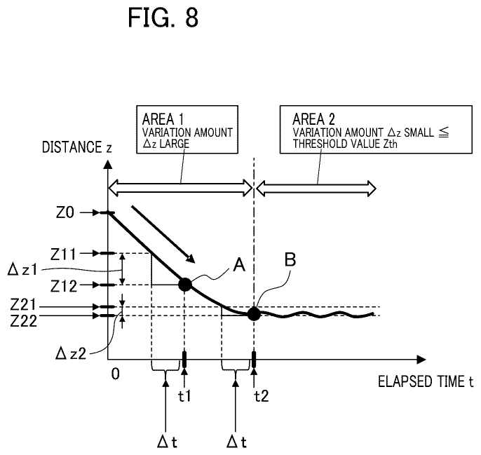

FIG. 8 is a schematic diagram explaining a determination method for a temporal variation amount for the distance z from the eye to the viewfinder in the First Embodiment. In step S006, as is shown in FIG. 8, the time series variation amount for the distance z from the eye to the viewfinder is acquired, and a determination is performed in the manner described below as to whether or not the variation range for within a predetermined time period becomes less than the threshold value, and is time series stabilized.

The graph in FIG. 8 shows the elapsed time on the horizontal axis and the distance z from the eye until the viewfinder on the vertical axis, and at the point in time time t=0, the distance is distance z=z0. A state is shown in which from this state, as time elapses, the eye gets closer to the viewfinder, and the distance z decreases.

If time elapses and it becomes approximately the time t2, the decreases in the distance z stop, and it becomes such that the value for z becomes almost constant. It can be determined that this is because the surroundings of the eye have come into contact with the box for the viewfinder, and after this there are no longer variations in the distance z.

It can be thought that the state in which the variations of the distance Z have almost completely stopped is the position of the eye in the normal posture of the camera for the user, and by performing personal identification by using an image of the eye from this time, it becomes such that it is possible to perform identification with an image in which the size of the eye is essentially a fixed size each time, and it is possible to suppress decreases in the identification precision.

During step S006, as is shown in FIG. 8, the time series data for the distance z is used, and a variation amount Δz for the distance d from this point in time until the point in time at which a predetermined time Δt has been reached is calculated. In addition, at the point in time at which this Δz drops to a predetermined threshold value Zth, it is determined that the eye has stopped approaching the viewfinder, and the distance z has become stable.

For example, if the point A is focused on during the time t1, the distance z at the time t1 is z=Z12, and in addition, at the time at which the time has increased from the time t1 to the predetermined time Δt, the distance z is shown as z=Z11.

During this period, the range of the variation amount for z is Δz1=Z12−Z11. Δz1 is the variation amount for the time at which the graph is clearly in a declining state, and Δz1>threshold value Zth, and therefore, it is determined that the variation amount is not stable.

Next, if the point B is focused on during the time t2, the distance z during the time t2 is z=z22, and in addition, during the time at which the time has increased from the time t2 to a predetermined time Δt, the distance z shows z=z21. The range for the variation amount for z during this time is Δz2=Z22−Z21.

As was explained above, Δz2 is in a range at which the graph begins to take a mostly fixed value around the time t2, and, Δz2≤Zth, and therefore, it is determined that this is stable. Therefore, during step S006, from t2 and after, if the area 2 is entered, it is determined that the size of the ocular image has become stable, that is, that the temporal variations in the distance z have become stable, and the processing proceeds to step S007. In contrast, in the case of the area 1 before t2, the processing returns to step S001.

In this context, step S006 functions as a state determining step (state determining unit) that determines a degree of temporal stability for the distance z as a state of the ocular image.

Next, during step S007, feature amounts for personal identification are extracted by inputting the ocular image that was acquired during the processing until step S006 into the personal identification unit 207. That is, in a case in which the pupil position of the user's eye has been detected, a user identification unit performs identification of the user during step S007.

During step S008, the personal identification unit 207 performs personal identification by using the feature amounts that were extracted during step S007. In this context, step S008 functions as a user identifying step (user identification unit) that identifies the user based on the ocular image.

FIG. 9 is a schematic diagram explaining a configurational example of a the personal identification unit 207. 302 is a CNN (Convolution Neural Network), 303 is a feature amount storage unit, 304 is a feature amount comparison unit, and 305 is a personal information assigning unit.

During step S2008, the feature amount comparison unit 304 sequentially compares the feature amounts that were extracted during S007 with a plurality of feature amounts that are stored in the feature amount storage unit 303. In addition, from among the plurality of feature amounts that have been stored, a feature amount is determined that has a degree of similarity that is equal to or greater than a predetermined threshold, and has the highest degree of similarity. The person who has this feature amount is identified as the personal identification results.

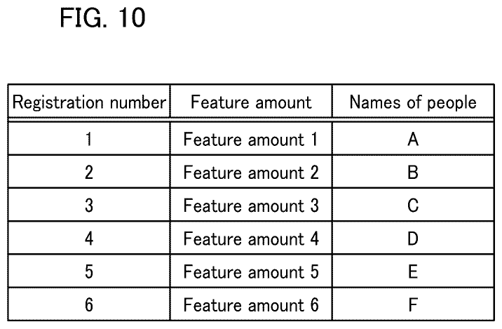

FIG. 10 is a diagram showing an example of a correspondence table for feature amounts and people that has been stored in the feature amount storage unit 303. The feature amount storage unit, which stores the correspondence table for feature amounts and people, as is shown in FIG. 10, is for example, provided as a portion of the memory 4, and when the above-described personal identification is performed, a correspondence table such as the above FIG. 10 is read out from the feature amount storage unit 303.

During step S009, it is determined whether or not a feature amount having a degree of similarity that is greater than or equal to the predetermined threshold value was found and the personal identification succeeded. In a case in which the personal identification has succeeded, the processing proceeds to step S010, and in a case in which a feature amount having a degree of similarity that is greater than or equal to the predetermined threshold value does not exist, and the personal identification did not succeed, the processing returns to step S001, and the processing is re-done from the image acquisition.

That is, control is performed such that in a case in which during step S009, the results of the identification by the user identification unit was not a predetermined result (that is, the identification did not succeed), the assignment determining unit will not assign the user information to the subject images.

During step S010, the personal identification results are assigned to images. That is, the user information (photographer information) that has been identified by the personal identification operations until step S090 is added (assigned) to captured images in the personal information assigning unit 305, after which these captured images are stored in, for example, an image storage area of the memory 4, and after this the processing flow in FIG. 6 is completed.

Note that the personal information assigning unit 305 adds (assigns) the user information (photographer information) by for example, superimposing this on the captured images as encoded watermark data. Conversely, the user information (photographer information) is added (assigned) as encoded data to image files for the captured images. In addition, for example, the captured images to which user information (photographer information) has been assigned are stored on an image storage area of the memory 4.

Note that the personal information assigning unit 305 compares the image capturing date and time for the ocular image that has been used in order to identify the user information (photographer information) with the image capturing date and time for the captured images of the subject, and in a case in which the two dates and times do not match or overlap, does not assign the user information (photographer information) to the captured images. In addition, in a case in which these two dates and times do match, and in a case in which these two times do overlap, the personal information assigning unit 305 assigns the user information (photographer information) to the captured images.

Note that step S010 functions as an assigning step (assigning means) for assigning user information relating to a user who has been identified by the user identifying step (user identification unit) to subject images that have been captured by the image capturing element while the user was looking into the viewfinder.

As has been explained above, during step S001 to step S010, the selection of images for which personal identification is performed, and the image capturing timing are optimized based on the detection state of the ocular information, and therefore, it is possible to maintain a high degree of personal identification precision.

Note that in the above description, step S005, and step S006 function as an assignment determining step (assignment determination) that performs control such that in a case in which it has been determined that the state of the ocular image from the state determining step does not fulfill predetermined conditions, the user information is not assigned to the subject images.

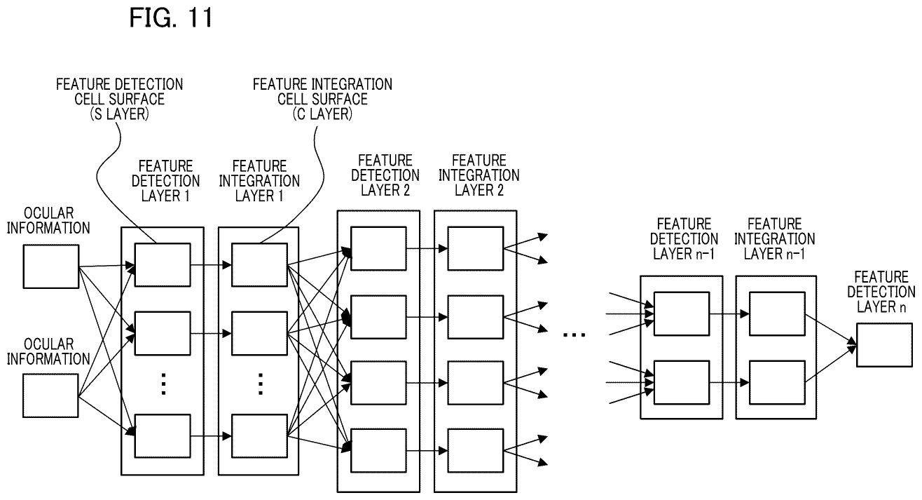

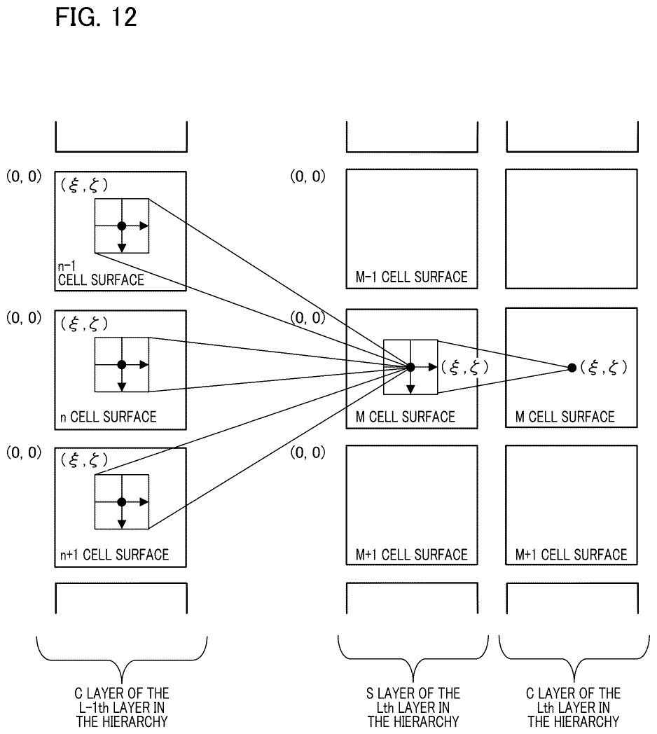

Next, FIG. 11, and FIG. 12 will be explained with respect to a configurational example of the above-described CNN 302. FIG. 11 is a diagram that explains a configurational example of the CNN 302, which performs personal identification from 2-dimensional data.

The flow of the processing in FIG. 11 performs input from the left edge, and the processing proceeds in the right direction. In the CNN 302, one set is made two layers, a layer referred to as a feature detection layer (an S layer), and a layer referred to as a feature integration layer (a C layer), and these sets are configured in a hierarchical manner.

First, in the Slayer in the CNN 302, a next feature is detected based on a feature that has been detected by the previous layer in the hierarchy. In addition, the features that have been detected in the S layer are integrated in the C layer, and this is a configuration in which these integrated features are transmitted to the next layer in the hierarchy as the detection results for this layer.

The S layer consists of a feature detection cell surface, and detects different features for each feature detection cell surface. In addition, the C layer consists of a feature integration cell layer, and performs pooling of the detection results from the feature detection layer from the previous stage in the hierarchy. Below, in a case in which distinguishing between the two cell surfaces is not particularly necessary, the feature detecting cell surface and the feature integrating cell surface will be referred to as the generic term “feature surfaces”. In the present embodiment, an n^{th} output layer, which is the final layer in the hierarchy, is configured by only an S layer, and does not use a C layer.

FIG. 12 is a diagram explaining a detailed example of the feature detection processing in the feature detection cell surface, and the feature integration processing in the feature integration cell surface. For example, a feature detecting cell surface (S layer) for a L^{th} layer in the hierarchy is configured by a plurality of feature detection neurons, and the feature detection neurons are coupled in a pre-determined structure in the C layer of an L−1^{th} layer of the hierarchy, which is the previous layer in the hierarchy.

In addition, for example, the feature integration cell surface (C layer) of the L^{th} layer in the hierarchy is configured by a plurality of feature integration neurons, and the feature integration neurons are coupled in a predetermined structure to the S layer of the same layer in the hierarchy. In this context, for example, inside of the M^{th} cell surface of the S layer of the L^{th} layer in the hierarchy, the output value for the feature detection neuron at the position (ξ, ζ) in FIG. 12 is written as:

$${y}_{M}^{LS} ( ξ , ζ ) .$$

In addition, inside the M^{th} cell surface of the C layer of the L^{th} layer in the hierarchy, the output value for the feature integration neuron at the position (ξ, ζ) is written as:

$${y}_{M}^{LC} ( ξ , ζ ) .$$

At this time, if the coupling coefficients for each of the neurons are made the following, then it is possible to represent each of the output values as shown in the following Formula 1, and Formula 2.

$$\begin{matrix}{w}_{M}^{LS} ( n , u , v ) \\ {w}_{M}^{LC} ( u , v )\end{matrix}$$

(coupling coefficients for the neurons)

$${y}_{M}^{LS} ( ξ , ζ ) ≡ f ( {u}_{M}^{LS} ( ξ , ζ ) ) ≡ f \{ {\sum }_{n , u , v} {w}_{M}^{LS} ( n , u , v ) \cdot {y}_{n}^{L - 1 C} ( ξ + u , ζ + v ) \} \qquad Formula 1$$

$${y}_{M}^{LS} ( ξ , ζ ) ≡ {u}_{M}^{LS} ( ξ , ζ ) ≡ {\sum }_{u , v} {w}_{M}^{LS} ( u , v ) \cdot {y}_{M}^{LS} ( ξ + u , ζ + v ) \qquad Formula 2$$

Note that f in the Formula 1 is an activation function, and it is sufficient if this is a sigmoid function such as a logistic function, a hyperbolic tangent function, and the like, and for example, this may also be realized by a tanh function. The above described

$${u}_{M}^{LS} ( ξ , ζ )$$

is an internal state of the feature detection neuron in the position (ξ, ζ) in the M^{th} cell surface of the S layer of the L^{th} layer in the hierarchy.

The Formula 2 is a simple linear sum that does not use an activation function. In a case in which an activation function is not used, such as in the Formula 2, the internal state of the neuron, and the output value, are equal.

$${u}_{M}^{LC} ( ξ , ζ )$$

(Internal state of the neuron)

$${y}_{M}^{LC} ( ξ , ζ )$$

(Output value)

In addition,

$${y}_{n}^{L - 1 C} ( ξ + u , ζ + v )$$

of the Formula 1 is referred to as the coupling destination output value for the feature detection neuron, and

$${y}_{M}^{LS} ( ξ + u , ζ + v )$$

of the Formula 3 is referred to the coupling destination output value for the feature integration neuron.

Next, ξ, ζ, u, v, and n from the Formula 1, and the Formula 2 will be explained. The position (ξ, ζ) corresponds to positional coordinates on the input image, and for example, in a case in which

$${y}_{M}^{LS} ( ξ , ζ )$$

is a high output value, this means that there is a high possibility that a feature that will be detected in the M^{th} cell surface of the S layer of the L^{th} layer in the hierarchy exists in the pixel position (ξ, ζ) of the input image.

In addition, in the formula 2, this means the n^{th} cell surface of the C layer of the L−1^{th} layer in the hierarchy, and is referred to as the integration destination feature number. Fundamentally, product-sum calculations are performed for all of the cell surfaces that exist in the C layer of the L−1^{th} layer of the hierarchy.

(u, v) are the relative position coordinates for the coupling coefficient, and the product-sum calculations are performed in the limited range of (u,v) according to the size of the feature to be detected. A range such as the limited (u, v) is referred to as a receptive field. In addition, the size of the receptive field is referred to below as the receptive field size, and is represented by the number of horizontal pixels x number of vertical pixels in the coupled range.

In addition, in the Formula 1, when L=1, that is, in the first S layer, this becomes

$${y}_{n}^{L - 1 C} ( ξ + u , ζ + v )$$

The input image becomes

$${y}^{{in}_{image}} ( ξ + u , ζ + v )$$

The input position map becomes

$${y}^{in\_posi \_map} ( ξ + u , ζ + v ) .$$

Incidentally, the distribution of the neurons and pixels is discrete, and the coupling destination feature numbers are also discrete, and therefore, ξ, ζ, u, v, and n are not consecutive variables, and are discrete values. In this context, ξ, and ζ are non-negative integers, n is a natural number, u, and v are integers, and these are all limited ranges.

$${w}_{M}^{LS} ( n , u , v$$

from among the Formula 1 is the coupling coefficient distribution for detecting a predetermined feature, and it becomes possible to detect the predetermined feature by adjusting this to an appropriate value.

This adjustment of the coupling destination coefficient is learning, and a variety of test patterns are provided during the construction of the CNN, and the adjustment of the coupling coefficient is performed by repeatedly gradually correcting the coupling coefficient such that

$${y}_{M}^{LS} ( ξ , ζ )$$

becomes an appropriate output value.

Next,

$${w}_{M}^{LC} ( u , v )$$

from among the Formula 2 is used as a two-dimensional Gaussian coefficient, and it is possible to represent this as is shown in the following Formula 3

$${w}_{M}^{LC} ( u , v ) = \frac{1}{2 {πσ}_{LM}^{2}} •exp ( \frac{{u}^{2} - {v}^{2}}{2 {σ}_{L , M}^{2}} ) \qquad Formula 3$$

In this context as well, (u,v) is a limited range, and therefore, in the same manner as the explanation of the feature detection neuron, the limited range is called the reception field, and the size of this range is referred to as the reception field size. In this context, it is sufficient if this reception field size is set to an appropriate value according to the size of the M^{th} feature of the S layer of the L^{th} layer in the hierarchy.

In the Formula 3, σ is a feature size factor, and it is sufficient if this is set to an appropriate constant according to the reception field size. Specifically, this should be set such that it becomes a value such that the outermost value of the reception field can be thought to be essentially 0.

In the CNN of the present embodiment, by performing the above such calculations in each layer of the hierarchy, in the S layer of the final layer in the hierarchy, personal identification is performed, and an appropriate line of sight correction coefficient is applied to an individual who is using the apparatus by determining which user is using the apparatus.

That is, in a case in which during step S005 to step S006 of FIG. 6, the pupil position was able to be sufficiently detected, and the temporal variation amount for the distance z from the eye until the viewfinder has become stable, the processing proceeds to the feature amount calculating for an individual that occurs during step S007. That is, the selection of the image on which the feature amount calculation for the individual will be performed and the timing at which the feature amount calculation will be performed are controlled.

In this manner, in the First Embodiment, it is possible to provide an image capturing apparatus and an individual information assigning apparatus that make it possible to maintain a high degree of personal identification precision by collectively performing detection of ocular information and optimizing the selection of the image on which personal identification will be performed and the timing of the image capturing by taking into account the results of the ocular information detection.

### Second Embodiment

Note that although in the First Embodiment, an example was given of the digital camera 1 as the image capturing apparatus, the present disclosure is not limited thereto. That is, it is sufficient if the image capturing apparatus is a device that has an eyepiece that the photographer brings their eye toward, and detects ocular image information for a photographer by using an ocular image sensor that has been provided on the eyepiece, and performs detection of ocular information and personal identification based on this ocular image by detecting the ocular information for the photographer. For example, the image capturing apparatus may also be a head-mounted XR apparatus, as is shown in FIG. 13.

FIG. 13A, and FIG. 13B are schematic diagrams explaining examples of a head-mounted XR apparatus as an image capturing apparatus according to the Second Embodiment. Note that XR is an abbreviation of Extended Reality, and Cross Reality.

The XR device of FIG. 13 acquires ocular images independently on the right and left sides, and is a head-mounted display apparatus 100 that has a unit that detects ocular information from these images and that performs personal identification. FIG. 13A is a front perspective view of the head-mounted display apparatus 100, and FIG. 13B is a rear perspective view of the head-mounted display apparatus 100.

501 is a lens element, and the user of the head-mounted display apparatus views the scenery of the physical world through this lens element 501. 502 is a virtual image display element, and is display apparatus with a so-called see-through head-mounted format, in which it is made such that virtual images are superimposed in the field of vision of the right and left eyes of the user, who is viewing the outside world through the optical system.

503 is an illumination light source drive circuit, and 13a, and 13b are both light sources such as light emitting diodes, and the like that irradiate the user (photographer) with infrared light, and each of these light sources irradiates the eyes of the user. A portion of the illuminating light that has been reflected off of the eyes is concentrated in the ocular image sensor 17.

520 is an outside world-use image capturing unit, and is a unit that captures images of the scenery of the outside world in a direction that the face of the user (photographer) is facing. The outside world-use image capturing unit includes an image capturing element.

The head-mounted display apparatus 100 is also made to perform personal identification operations such as login operations after the apparatus has been mounted on the head of the user, and the like. In addition, in the same manner as in the First Embodiment, detection of the ocular information and personal identification are performed by the personal identification unit by using the ocular images that are captured via the light receiving lens 16 by the ocular image sensor 17, which has been placed directly in front of the eyes of the user.

The distance between the eyes and the ocular image sensor 17 that has been disposed on the eyepiece varies during the course of the head-mounted display apparatus 100 being mounted on the head of the user, and therefore, there are cases in which the precision of the ocular images, and how the eyes appear within the angle of view such as the size of the eyes and the like change during this time.

However, in the Second Embodiment as well, in the same manner as in the First Embodiment, it is possible to increase the precision of the personal identification by optimizing the selection of the images on which the personal identification will be performed, the image capturing timing, and the like based on the detection results for the ocular information.

### Third Embodiment

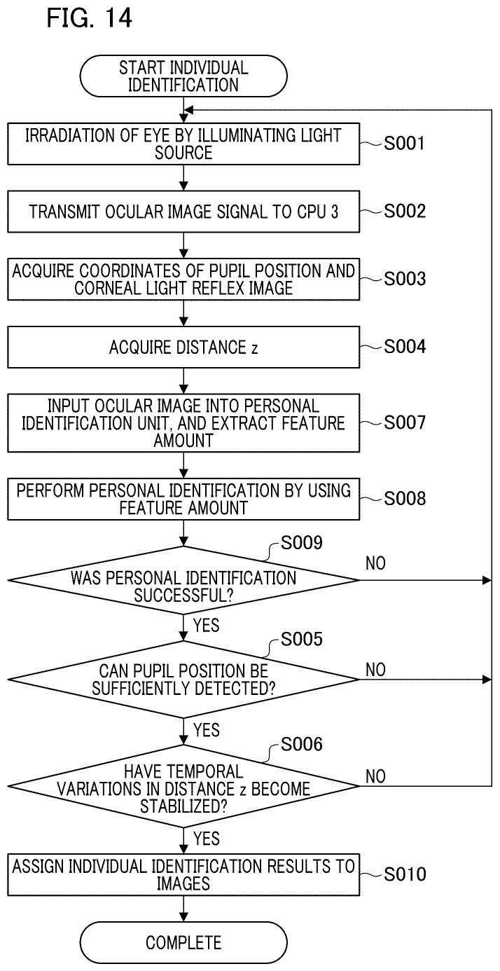

FIG. 14 is a flowchart showing an example of personal identification processing according to the Third Embodiment. Note that the processes for each step of the flowchart in FIG. 14 are performed in order by the CPU 3 that serves as a computer and the like executing a computer program that has been stored on the memory. Note that the steps in FIG. 14 that have been given the same reference numbers as steps in FIG. 6 represent the same processing and therefore, explanations thereof will be omitted.

In the processing flow of FIG. 14, feature amount calculation is performed for all of the ocular images that have been obtained, and after this, it is determined which feature amount will be used to perform the personal identification based on the detection state for the pupil position in each ocular image, and the temporal variation amount for the distance z from the eye to the viewfinder.

That is, as is shown in FIG. 14, by performing the processing for step S007, step S008, and step S009 before the determination processing in step S005 and step S006, the processing from the feature amount extraction for the personal identification and the calculation of the personal identification results are performed in advance.

In this manner, in the Third Embodiment, the personal identification results have already been calculated up to step S009, and during step S005, and step S006, it is determined whether or not these personal identification results that have been calculated may be used based on the ocular information that has been obtained.

That is, in the present embodiment, the user identification unit performs user identification, and also applies the results of the identification of the user in a case in which the pupil position of the eye of the user has been detected. In addition, this is a configuration in which in a case in which this ocular information is an image that does not fulfill predetermined conditions, the processing does not proceed to step S010, and the user information that has been identified is not written onto the images.

### Fourth Embodiment

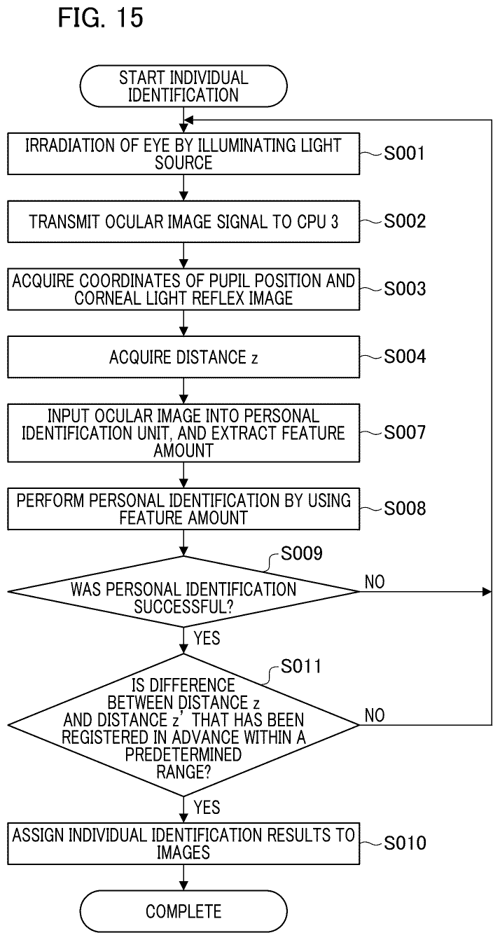

In the Fourth Embodiment, in addition to corresponding the feature amounts and people, as was shown in FIG. 10, a distance z′ from the eye until the viewfinder is also corresponded with people and stored in advance, the information for the distance z′ is also used, and processing such as that in the flowchart of FIG. 15 is performed.

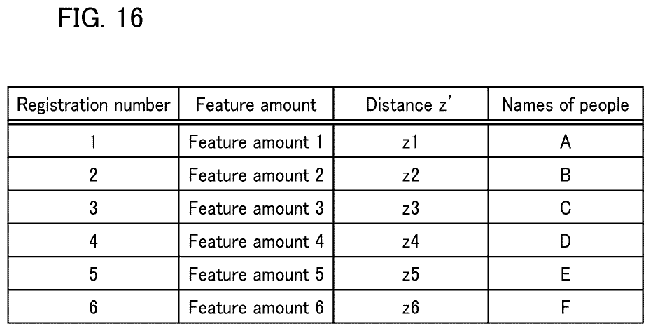

FIG. 15 is a flowchart showing an example of personal identification processing according to the Fourth Embodiment, and FIG. 16 is a diagram showing an example of a correspondence table for feature amounts, people, and distances z′ according to the Fourth Embodiment. Note that the processes for each step of the flowchart in FIG. 15 are performed in order by the CPU 3 that serves as a computer, and the like executing a computer program that has been stored on the memory. Note that the steps in FIG. 15 that have been given the same reference numbers as steps in FIG. 6, and FIG. 14 represent the same processing and therefore, explanations thereof will be omitted.

In the present embodiment, in a case in which it has been determined that the personal identification during step S009 succeeded, the processing proceeds to step S011. In addition, during step S011, it is determined whether or not the difference between the distance z from the eye to the camera, which was acquired during the previous step S004, and the distance z′ that was registered in advance together with the feature amount as is shown in FIG. 16, is within a predetermined range.

As is shown in FIG. 16, in the present embodiment, when the feature amounts are registered in advance, instead of corresponding just the feature amounts and people, as is shown in FIG. 10, distances z′ from the eye to the viewfinder are also calculated and corresponded with people, and are thereby stored in the feature amount storage unit 303 within the memory 4.

In addition, if the distance z from the eye to the camera that was acquired during step S004 is within a predetermined error range from the distance z′ that was stored in the feature amount storage unit 303, the processing proceeds to the next step S010, whereas if this is not within the predetermined error range, the processing returns to S001, and the processing is re-done from the acquisition of the image.

That is, during step S011, the state detection unit determines that the predetermined conditions have not been fulfill in a case in which the difference between the distance from the eye of the user to the viewfinder and the predetermined distance that has been registered in advance for each user is greater than or equal to a predetermined threshold value, and the processing returns to step S001.

In this manner, in the Fourth Embodiment, the personal identification results are assigned to images by using ocular images that have been image captured at a distance z that is in a predetermined range in relation to the distance z′ from the eye until the viewfinder from when the feature amounts for eyes were registered in advance. Therefore, it is possible to perform a comparison of the time at which the individuals were registered and the time of use using the same image conditions (the brightness of the image, the size of the eye, the distance z, and the like), and it is possible to perform the personal identification with a higher degree of precision.

Next, during step S010, the user information (photographer information) that has been identified is assigned by embedding this as, for example, encoded metadata into the files for the captured images. Conversely, the user information may also be assigned to the images by being superimposed on the captured images as encoded watermarked data. In addition, the captured images are stored on the memory 4, and the like, and the processing flow of FIG. 15 is completed.

As has been explained above, it is possible to maintain a high degree of personal identification precision by performing a comparison between the detection results for the ocular information at the time of use of the apparatus, and the ocular information that has been stored in advance, and optimizing the selection of the personal identification results based on these results.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the image capturing apparatus and the like through a network or various storage media. Then, a computer (or a CPU, an MPU, or the like) of the image capturing apparatus and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2024-218117, filed on Dec. 12, 2024, which is hereby incorporated by reference herein in its entirety.

What is claimed is:

1. An image capturing apparatus comprising:
an image capturing element configured to capture subject images;
a view finder for confirming images of subjects;
an ocular image sensor configured to capture ocular images of a user who is looking into the viewfinder;
at least one processor; and
a memory coupled to the at least one processor, the memory storing instructions that, when executed by the at least one processor, cause the at least one processor to:
determine a state of the ocular images
identify the user based on the ocular images;
assign user information relating to the user who has been identified to the subject images that have been captured by the image capturing element while the user is looking into the viewfinder; and
perform control such that in a case in which it has been determined that the state of the ocular images does not fulfill predetermined conditions, the user information is not assigned to the subject images.

2. The image capturing apparatus according to claim 1, wherein the memory stores further instructions that, when executed by the at least one processor cause the at least one processor to:
perform control such that the user information is not assigned to the subject image in a case in which results of identifying the user are not predetermined results.

3. The image capturing apparatus according to claim 1, the memory storing further instructions that, when executed by the at least one processor cause the at least one processor to:
perform identification of the user in a case in which a pupil position of an eye of the user has been detected.

4. The image capturing apparatus according to claim 1, wherein the memory stores further instructions that, when executed by the at least one processor, cause the at least one processor to:
use results of identifying the user in a case in which a pupil position of an eye of the user has been detected along with identifying the user.

5. The image capturing apparatus according to claim 1, wherein the memory stores further instructions that, when executed by the at least one processor, cause the at least one processor to:
determine that the predetermined conditions have not been fulfilled in a case in which variations in a distance from an eye to the viewfinder during a predetermined period of time are greater than or equal to a predetermined threshold value.

6. The image capturing apparatus according to claim 1, wherein the memory stores further instructions that, when executed by the at least one processor, cause the at least one processor to:
identify the user when the user has brought their eye toward the finder in order to start image capturing of the subject.

7. The image capturing apparatus according to claim 1, wherein the memory stores further instructions that, when executed by the at least one processor, cause the at least one processor to:
determine that predetermined conditions have not been fulfilled in a case in which a difference between a distance from an eye of the user to the viewfinder and a predetermined distance that has been registered in advance for each user is greater than or equal to a predetermined threshold value.

8. An image capturing method using an image capturing apparatus that has an image capturing element configured to capture subject images; a view finder for confirming images of subjects; and an ocular image sensor configured to capture ocular images of a user who is looking into the viewfinder, the image capturing method comprising:
determining a state of the ocular images
identifying the user based on the ocular images;
assigning user information relating to the user who has been identified to the subject images that have been captured by the image capturing element while the user is looking into the viewfinder; and
performing control such that in a case in which it has been determined that the state of the ocular images does not fulfill predetermined conditions, the user information is not assigned to the subject images.

9. A non-transitory computer-readable storage medium configured to store a computer program for an image capturing apparatus having an image capturing element configured to capture subject images; a view finder for confirming images of subjects; and an ocular image sensor configured to capture ocular images of a user who is looking into the viewfinder, wherein the computer program causes the image capturing apparatus to execute the following processes:
determining a state of the ocular images
identifying the user based on the ocular images;
assigning user information relating to the user who has been identified to the subject images that have been captured by the image capturing element while the user is looking into the viewfinder; and
performing control such that in a case in which it has been determined that the state of the ocular images does not fulfill predetermined conditions, the user information is not assigned to the subject images.
